(19) United States
(12) Patent Application Publication
(10) Pub. No.: US 2008/0256386 A1
(43) Pub. Date: Oct. 16, 2008

(54) Raid configuration indication in network attached storage

(76) Inventors: Paul Boerger, Ft. Collins, CO (US); Fred Charles Thomas, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/786,126

(22) Filed: Apr. 11, 2007

(51) Int. Cl. G06F 11/00

(52) U.S. Cl. 714/6

(57) ABSTRACT

In one embodiment a network attached storage device comprises at least one storage media, a storage controller to manage input/output requests directed to the at least one storage media, and a RAID interrogation module to receive a RAID configuration query, wherein the RAID configuration query includes a volume identifier that identifies a storage volume, accesses a RAID configuration table in a memory module coupled to the network attached storage device, and presents RAID configuration data obtained from the RAID configuration table.

### BACKGROUND

The term Network Attached Storage (NAS) refers to a dedicated data storage device(s) connected directly to a computer network to provide centralized data access and storage services to one or more network clients such as, e.g., a personal computer. NAS devices typically comprise one or more storage media such as, e.g., magnetic disk drives, optical drives, magneto-optical drives, tape drives, or the like. NAS devices may implement a file sharing operating system such as, e.g., Network File System (NFS) to provide data storage and access management services to network clients. The storage media may be configured to implement logical storage objects such as, e.g., one or more logical volumes and may implement data protection techniques such as, e.g., RAID (redundant array of inexpensive/independent disks).

Some NAS devices are portable. Users of portable NAS devices may use the NAS devices in multiple different network settings and may access the NAS devices from multiple different computer systems. Different RAID configurations may require specific drivers to be installed on a computer system to enable the computer system to communicate with the NAS devices.

### BRIEF DESCRIPTION OF THE DRAWINGS

FIG. 1 is a schematic illustration of one embodiment of a network attached storage environment.

FIG. 2 is a schematic illustration of a network attached storage device in accordance with one embodiment.

FIG. 3 is a flowchart illustrating operations in one embodiment of a method of RAID configuration indication in network attached storage.

FIG. 4 is a schematic illustration of a RAID configuration table in accordance with one embodiment.

FIG. 5 is a flowchart illustrating operations in one embodiment of a method of RAID configuration indication in network attached storage.

### DETAILED DESCRIPTION

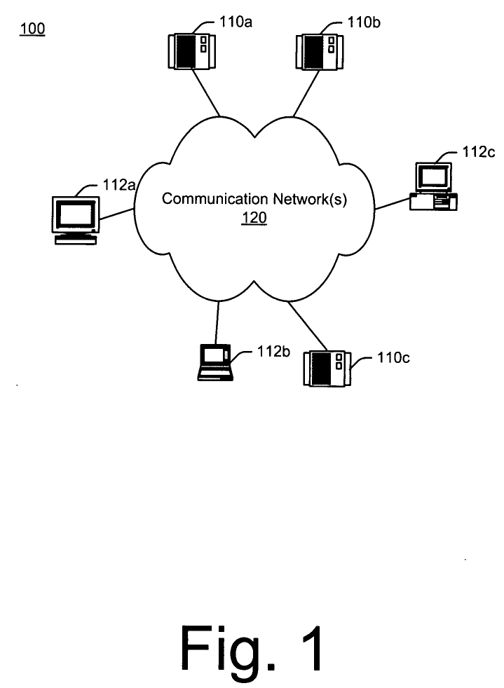

FIG. 1 is a schematic illustration of one embodiment of a network attached storage environment. Environment 100 may comprise a one or more network attached storage devices 110a, 110b, 110c, (referred to generally by 110) connected to one or more network clients 112a, 112b, 112c, (referred to generally by 112) by a communication network 120.

Network attached storage devices 110 may be implemented as one or more communicatively connected storage devices. Exemplary storage devices may comprise, but are not limited to, the ProLiant™ line of storage devices commercially available form Hewlett-Packard Corporation of Palo Alto, Calif., USA. In some embodiments, at least a portion of communication network 120 may be implemented as a private, dedicated network such as, e.g., a local area network (LAN) or a wide area network (WAN). Alternatively, portions of communication network 120 may be implemented using public communication networks pursuant to a suitable communication protocol such as, e.g., the Internet.

Network clients 112 may be implemented as computing devices such as, e.g., a networked computer 112a, a laptop computer 112b, a desktop computer 112c, or the like. Applications running on network clients 112 may initiate file access requests to access information stored in network attached storage devices 110. Network attached storage devices 110 receive file access requests and, in response, locate and return the requested information to the network client that originated the request.

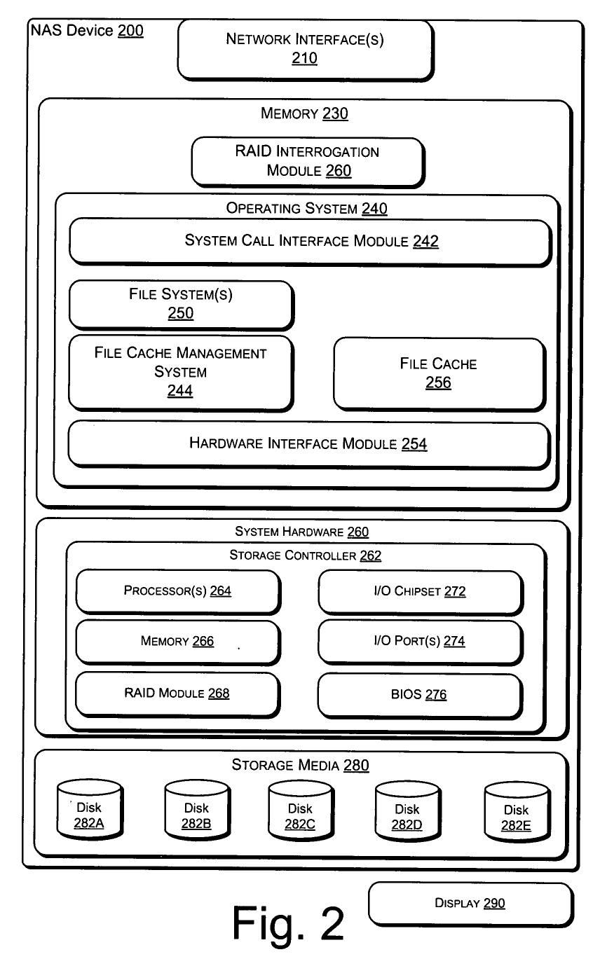

FIG. 2 is a schematic illustration of one embodiment of a network attached storage (NAS) device 200, which may be used to implement one or more of network attached storage devices 110 depicted in FIG. 1. Referring to FIG. 2, network storage device 200 comprises one or more network interfaces 210 which enables a communication connection with a network such as, e.g., network 120.

Network interface 210 may comprise an input/output (I/O) port to provide a physical connection with a network. For example, network interface 210 may comprise an Ethernet port. Network interface 210 may comprise a network interface card (NIC), also commonly referred to as a network adapter or a network card. The NIC manages I/O operations to enable NAS device 200 to communicate over a network. Alternatively, the operations of the NIC may be implemented on a main circuit board such as, e.g., a motherboard of NAS device 200.

NAS device 200 comprises storage media 280. For example, storage media 280 may be embodied as one or more arrays of magnetic disk drives 280A, 280B, 280C, 280D, 280E, referred to generally herein by reference numeral 280. Alternatively, storage media 280 may comprise optical, magneto-optical, or electro-optical storage media.

NAS device 200 further comprises system hardware 260, including a storage controller 262, which in turn comprises at least one processor 264, a memory module 266, and a RAID module 268. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. Memory module 266 may be implemented as any type of computer-readable memory such as random access memory (RAM), non-volatile RAM (NV-RAM), dynamic RAM (DRAM), magnetic memory, optical memory, read only memory (ROM), or combinations thereof.

RAID module 268 may be implemented as logic instructions which reside on a computer readable medium such as computer memory 266 and which are executable on a processor such as processor 264. Alternatively, RAID module may be embodied as a discrete logic circuit implemented on, or coupled to, storage controller 262.

In some embodiments, RAID module 268 implements RAID data protection techniques on storage media 280. In some embodiments RAID module may be configured to implement at least one of a plurality of configurations Redundant Array of Independent Disks (“RAID”). Such configurations may include RAID0, RAID1+0, RAID1, RAID4, RAID5, RAID5+0, or other suitable configurations as desired. U.S. Pat. No. 6,694,479 to Murthy, et al., and U.S. Pat. No. 6,643,822 to Murthy, both of which are assigned to the common assignee of the present application and are incorporated herein by reference, illustrate various RAID configurations.

In a RAID configuration, a plurality of storage media 280 are provided for redundancy. In a RAID configuration, data is “striped” across multiple storage media 280. For example, a data set is divided up and stored across two or more storage devices. In a RAID1+0 configuration, storage devices are configured in a “mirrored” implementation in which data may be striped across two storage devices and the same data is also striped across two other storage devices. A RAID4 configuration includes a parity storage device in addition to data storage devices. Information stored on the parity storage device generally is the exclusive OR of the data on the data storage devices. In the event of a device failure, data on any of the data or parity storage devices can readily be recovered by computing the exclusive OR of the remaining storage devices. RAID5 is similar to RAID4, but parity information is rotated among the various data drives (i.e., there is no dedicated parity drive).

Storage controller 262 further comprises an input/output chipset 272, such as, for example, a PCI-Express (PCIE), I/O ports 274, and a basic input/output system (BIOS), which manages the boot process for storage controller 260. In some embodiments system hardware may include additional components, such as at least one display 290 which may be embodied as, for example, a liquid crystal display (LCD) panel.

NAS device 200 further comprises system random access memory and/or read-only memory 230, which may be integrated with memory 266 in some embodiments. Memory 230 comprises an operating system 240 for managing operations of NAS device 200. In one embodiment, operating system 240 comprises a hardware interface module 254 that provides an interface to system hardware. The particular embodiment of operating system 240 is not critical to the subject matter described herein. Operating system 240 may be embodied as a UNIX operating system or any derivative thereof (e.g., Linux, Solaris, etc.) or as a Windows® brand operating system.

Operating system 240 comprises (or interfaces with) a file system(s) 250 that manages files used in the operation of NAS device 200. For example, file system(s) 250 may implement one or more of a Network File System (NFS) protocol, a Common Internet File System (CIFS) protocol, or the like. In one embodiment operating system 240 may comprise a file cache management system 244 interposed logically between the file system(s) 250 and underlying modules such as, e.g., the hardware interface module 254. File cache management system 244 interfaces with the file system(s) 250 to manage the file cache 256 as a resource that may be shared between users of the computer system, e.g., on a per-workload basis.

Operating system 240 further comprises a system call interface module 242 that provides an interface between the operating system 240 and one or more application modules that execute on NAS device 200.

NAS storage device 200 further comprises a virus scanning module 260. In some embodiments, virus scanning module is embodied as a software module that executes on processor(s) 212. In such embodiments, virus scanning module 260 executes as a background process to scan files stored on NAS storage device 200 for viruses, Trojan horses, worms, or the like.

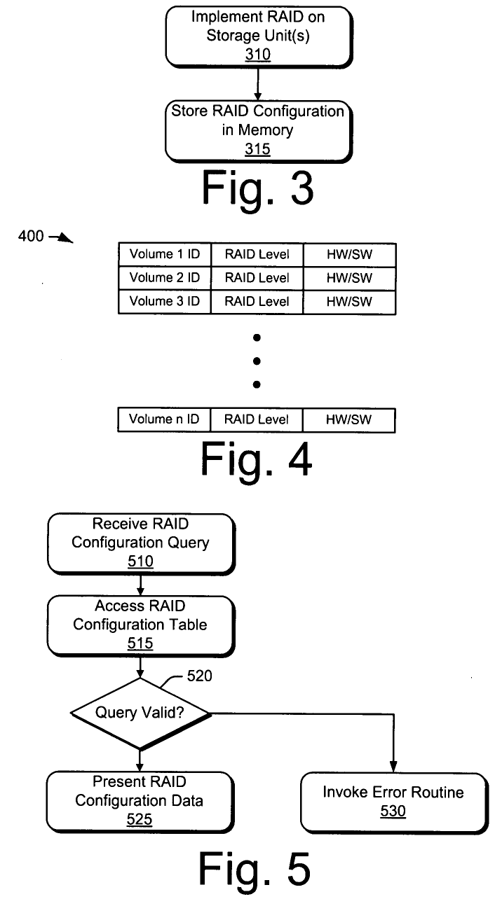

NAS storage device 200 further comprises a RAID interrogation module 232 that provides an indication of the RAID configuration implemented on storage device 200. Operations implemented by some embodiments of RAID module 268 and RAID interrogation module 232 are described with reference to FIGS. 3-5.

FIG. 3 is a flowchart illustrating operations in one embodiment of a method of RAID configuration indication in network attached storage, and FIG. 4 is a schematic illustration of a RAID configuration table in accordance with one embodiment. The operations of FIG. 3 cause RAID module in NAS device 200 populate a RAID configuration table.

At operation 310 RAID module 268 implements RAID on storage unit(s) of the storage media 280 of network attached storage device 200. In some embodiments the RAID module 268 may be configured to implement a single RAID volume that consumes the entire storage space provided by storage media 280. In some embodiments RAID module 268 may receive a request to define a plurality of logical volumes from the storage space provided by storage media 280. For example, network attached storage device 200 may permit users to define multiple logical volumes from the storage space provided by storage media 280. The logical volumes may have different RAID levels, and may be configured as hardware enabled RAID or software enabled RAID.

At operation 315 the RAID module 268 stores the RAID configuration for the logical volume(s) defined in the storage space provided by storage media 280 in a RAID configuration table. Referring to FIG. 4, the RAID configuration table 400 may be implemented as a data file stored in memory module 266. RAID configuration table may include an entry for each volume in the storage space provided by storage media 280. Each entry may include a volume identifier that identifies the logical volume and RAID configuration data associated with the volume. For example, the RAID configuration data may include a RAID level and an indicator of whether RAID is implemented at a hardware level or at a software level in storage controller 262.

FIG. 5 is a flowchart illustrating operations in one embodiment of a method of RAID configuration indication in network attached storage. Referring to FIG. 5, at operation 510 a RAID configuration query is received. In some embodiments the RAID configuration query may be initiated by the BIOS 276 or a routine invoked by the BIOS when network attached storage device 200 is booted, while in other embodiments a RAID configuration query may be received from a remote computer system, such as one or more of network clients 112, via the communication network 120.

In some embodiments, the RAID configuration request includes at least one volume identifier that identifies at least one volume defined in the storage space provided on storage media 280. By contrast, in some embodiments the RAID configuration request may include a wildcard identifier that serves to request RAID configuration information on all volumes defined in the storage space provided on storage media 280.

At 515 the RAID interrogation module 260 accesses the RAID configuration table 400. For example, the RAID interrogation module 260 may search the RAID configuration table for a volume identifier that matches the volume identifier received in the RAID configuration query. If the RAID configuration query is not valid (i.e., if there is not a matching identifier in the RAID configuration table 400), then an error routine and/or error indicator may be invoked at 530. In some embodiments the error routine may comprise generating an error message for presentation on a user interface such as, e.g., display 290.

By contrast, if the RAID configuration query is valid, then at least one RAID configuration parameter associated with the volume(s) identified in the RAID configuration request may be retrieved from RAID configuration table 400 and presented via an interface. For example, in some embodiments the RAID configuration parameter(s) are presented on display 290. In some embodiments, the RAID configuration parameter(s) may be transmitted to a computer system 112 that initiated the RAID configuration request, e.g., via communication network 120. The computer system 112 may then use the configuration parameter(s) to select at least one driver to invoke to communicate with network attached storage device 200.

In some embodiments, the operations of FIG. 3 may be repeated each time a new storage volume is created in the storage space provided by storage media 280. Thus, the subject matter described herein enables a network attached storage device 200 to construct and maintain a data table that stores RAID configuration information for volume(s) define in the storage space provided by storage media 280 and to present the RAID configuration information via a user interface or to a computer system that utilizes the storage provided by storage media. This information facilitates the portability of network attached storage device 200.

The methods described herein may be embodied as logic instructions stored on a computer-readable medium. When executed on a processor, the logic instructions cause a general processor to be programmed as a special-purpose machine that implements the described methods. The processor, when configured by the logic instructions to execute the methods recited herein, constitutes structure for performing the described methods.

Some embodiments may be provided as computer program products, which may comprise a machine-readable or computer-readable medium having stored thereon instructions used to program a computer (or other electronic devices) to perform a process discussed herein. The machine-readable medium may comprise, but is not limited to, floppy diskettes, hard disk, optical disks, CD-ROMs, magneto-optical disks, ROMs, RAMs, erasable programmable ROMs (EPROMs), electrically erasable EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is comprised in at least an implementation. The appearances of the phrase “in one embodiment” in various places in the specification are not necessarily all referring to the same embodiment.

What is claimed is:

1. A method, comprising:
receiving, in a network attached storage device, a RAID configuration query, wherein the RAID configuration query includes a volume identifier that identifies a storage volume;
accessing a RAID configuration table in a memory module coupled to the network attached storage device; and
presenting RAID configuration data obtained from the RAID configuration table.

2. The method of claim 1, wherein receiving, in a network attached storage device, a RAID configuration query comprises receiving a query from a boot operation implemented by a basic input/output system (BIOS) of the network attached storage device.

3. The method of claim 2, wherein receiving, in a network attached storage device, a RAID configuration query comprises receiving a query from a computer system coupled to the network attached storage device.

4. The method of claim 1, wherein accessing a RAID configuration table in a memory module coupled to the network attached storage device comprises:
searching the RAID configuration table for an identifier that matches the volume identifier received in the RAID configuration query; and
retrieving from the RAID configuration table at least one RAID configuration parameter associated with the identifier.

5. The method of claim 1, wherein accessing a RAID configuration table in a memory module coupled to the network attached storage device comprises:
searching the RAID configuration table for an identifier that matches the volume identifier received in the RAID configuration query; and
invoking an error routine or error indicator when the RAID configuration table lacks an identifier that matches the volume identifier received in the RAID configuration query.

6. The method of claim 1, wherein presenting RAID configuration data obtained from the RAID configuration table comprises presenting the RAID configuration data on a display coupled to the network attached storage device.

7. The method of claim 3, wherein presenting RAID configuration data obtained from the RAID configuration table comprises transmitting the RAID configuration data to the computer system coupled to the network attached storage device.

8. The method of claim 7, further comprising:
receiving the RAID configuration data in the computer system; and
selecting a RAID driver based at least in part on the RAID configuration data.

9. A network attached storage device, comprising:
at least one storage media;
a storage controller to manage input/output requests directed to the at least one storage media; and
a RAID interrogation module to:
receive a RAID configuration query, wherein the RAID configuration query includes a volume identifier that identifies a storage volume;
access a RAID configuration table in a memory module coupled to the network attached storage device; and
present RAID configuration data obtained from the RAID configuration table.

10. The network attached storage device of claim 9, further comprising a basic input/output system (BIOS) to generate the RAID configuration query.

11. The network attached storage device of claim 9, further comprising a computer system coupled to the network attached storage device to generate the RAID configuration query comprises receiving a query.

12. The network attached storage device of claim 9, wherein the RAID interrogation module:
searches the RAID configuration table for an identifier that matches the volume identifier received in the RAID configuration query; and
retrieves from the RAID configuration table at least one RAID configuration parameter associated with the identifier.

13. The network attached storage device of claim 9, wherein the RAID interrogation module:
searches the RAID configuration table for an identifier that matches the volume identifier received in the RAID configuration query; and
invokes an error routine or error indicator when the RAID configuration table lacks identifier that matches the volume identifier received in the RAID configuration query.

14. The network attached storage device of claim 9, wherein the RAID interrogation module presents the RAID configuration data on a display coupled to the network attached storage device.

15. The network attached storage device of claim 9, wherein the RAID interrogation module transmits the RAID configuration data to the computer system coupled to the network attached storage device.

16. A computer program product comprising logic instructions stored on a computer-readable medium which, when executed by a computer processor, configure the processor to:
receive a RAID configuration query, wherein the RAID configuration query includes a volume identifier that identifies a storage volume;
access a RAID configuration table in a memory module coupled to the network attached storage device; and
present RAID configuration data obtained from the RAID configuration table.

17. The computer program product of claim 16, further comprising logic instructions stored in a computer-readable medium which, when executed by the processor, configure the processor to:
search the RAID configuration table for an identifier that matches the volume identifier received in the RAID configuration query; and
retrieve from the RAID configuration table at least one RAID configuration parameter associated with the identifier.

18. The computer program product of claim 17, further comprising logic instructions stored in a computer-readable medium which, when executed by the processor, configure the processor to:
search the RAID configuration table for an identifier that matches the volume identifier received in the RAID configuration query; and
invoke an error routine or error indicator when the RAID configuration table lacks identifier that matches the volume identifier received in the RAID configuration query.

19. The computer program product of claim 17, further comprising logic instructions stored in a computer-readable medium which, when executed by the processor, configure the processor to present the RAID configuration data on a display.

20. The computer program product of claim 17, further comprising logic instructions stored in a computer-readable medium which, when executed by the processor, configure the processor to transmit the RAID configuration data to the computer system coupled to the network attached storage device.
